(19) United States
(12) Patent Application Publication
(10) Pub. No.: US 2006/0159268 A1
(43) Pub. Date: Jul. 20, 2006

(54) Method and system for device authentication in home network

(75) Inventors: Bae-eun Jung, Seongnam-si (KR); Kyung-hec Lee, Yongin-si (KR); Mi-suk Huh, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/326,294

(22) Filed: Jan. 6, 2006

(30) Foreign Application Priority Data
Jan. 20, 2005 (KR) 10-2005-0005508

(51) Int. Cl. H04K 1/00

(52) U.S. Cl. 380/270

(57) ABSTRACT

A method and system for authenticating a home device in a home network, includes generating a home key for authentication of the home device, receiving a secret key corresponding to the home device from the home device, encrypting the home key with the received secret key, and transmitting the encrypted home key to the home device. The home device decodes the encrypted home key using the secret key and then stores the home key. Accordingly, the authentication of the home device is performed without requiring a home server, which would cause an overhead, and the processing of a guest device and a revoked device are performed.

### CROSS REFERENCE TO RELATED APPLICATION

This application claims priority under 35 U.S.C. § 119 from Korean Patent Application No. 10-2005-0005508, filed on Jan. 20, 2005, in the Korean Intellectual Property Office, the entire contents of which are incorporated herein by reference.

### BACKGROUND OF THE INVENTION

1. Field of the Invention

Methods consistent with the present invention relate to authenticating a home device in a home network. More specifically, methods consistent with the present invention relate to authenticating a home device by generating a home key using a key distribution device and distributing the home key to respective home devices.

2. Description of the Related Art

“Kerberos” refers to an encryption-based security system that provides a mutual authentication to an application client and an application server in a distributed environment. In a kerberos, authentication is performed between a server and a client, and accordingly, respective home devices are registered with the server to be authenticated and a key is distributed to respective home devices via the server. Also, in order to authenticate respective home devices in a secret key-based authentication system, a secret key calculation is essential. However, according to a server-centralized authentication, the server has to participate every time that an authentication procedure is required for devices, which may cause an overhead of the server. Also, all home devices, including a visitor home device, must be registered with the server for use by a user.

Universal plug and play (UPnP) is a networking architecture that is based on the Windows ME and Windows XP operating systems and enables network home devices such as personal computers (PCs), personal digital assistants (PDAs), printers and wideband routers, and electric appliances to perform a “plug and play” in a home network. However, the UPnP architecture does not suggest any authentication with respect to an equivalent relationship, such as data transmission among devices, and cannot identify a client home device. Therefore, if a guest device appears, the UPnP architecture has to begin the first step to perform an authentication for the security of home network. Also, if a control point (CP) changes, an access control list entry (ACLEntry) has to be transmitted to a home device related the corresponding CP. Further, the UPnP is an opened key-based architecture and thus, it is difficult to implement the UPnP with respect to a computationally weak home device.

U.S. Pat. No. 6,064,297 discloses message authentication in a home network. According to U.S. Pat. No. 6,064,297, a message is authenticated by distributing a seed to devices belonging to the same group and using a one-way hash function based on a counter value and shared information. The method described in U.S. Pat. No. 6,064,297 provides a message format enhancement and an authentication method in a so-called X10 protocol. This message authentication method divides home devices in a wired environment into a predetermined number of groups, assigns group (identifiers) IDs to the groups, and displays the group IDs on a message used in communication, such that home devices allows only communication within the groups.

However, the authentication method disclosed in U.S. Pat. No. 6,064,297 does not suggest a distribution method for the seed and has no solution for the situation where a home device escapes from the home network. Since, as disclosed in U.S. Pat. No. 6,064,297, the authentication is limited to the home devices existing in the X10 protocol, an appearance of a guest device is not taken into account. Therefore, this conventional method is not suitable for a home device authentication in a home network.

### SUMMARY OF THE INVENTION

The present invention provides a method and system to authenticate a home device which assigns the same home key to home devices in a home network and, thus, requires no home server and does not cause an overhead.

According to an aspect of the present invention, there is provided a method to authenticate a home device in a home network, including generating a home key for authentication of the home device, receiving a secret key corresponding to the home device from the home device, encrypting the home key with the received secret key, and transmitting the encrypted home key to the home device. The home device decodes the encrypted home key using the secret key and stores the home key.

The receiving of the secret key from the home device may be performed through a location-limited channel.

Another aspect of the present invention provides a method to authenticate at least two home devices including a new device in a home network. The method includes receiving a secret key from the new device, encrypting a home key for authentication of the home device with the received secret key, and transmitting the encrypted home key to the new device. The new device decodes the encrypted home key using the secret key and stores the home key.

The receiving of the secret key from the new device and the transmitting of the encrypted home key to the new device may be performed through a location-limited channel.

Another aspect of the present invention provides a method to authenticate a home device in a home network, including updating a home key for authentication of the home device, encrypting the updated home key with a secret key of the home device, and transmitting the encrypted home key to the home device. The home device decodes the encrypted home key using the secret key and stores the home key.

The transmitting of the encrypted home key to the home device may be performed through a network channel including a location-limited channel.

Another aspect of the present invention provides a method to authenticate at least two home devices including an revoked device, including deleting secret key information including a secret key of the revoked device, updating a home key for authentication of the home device excluding the revoked device, encrypting the home key with a secret key of the home device, and transmitting the encrypted home key to the home device. The home device decodes the encrypted home key using the secret key and stores the home key.

The deleting of the secret key of the revoked device may include maintaining a device registration list including secret keys corresponding to the respective home devices, and deleting secret key information including a secret key of the revoked device from the device registration list.

Another aspect of the present invention provides a method to authenticate a guest device in a home network, including receiving guest device information, and generating and transmitting guest authentication information including a guest key corresponding to a pre-transmitted home key, and if an access of the guest device is over, updating a home key for authentication of the home device excluding the guest device.

The guest authentication information may include information about a guest key calculated based on the home key and available period information, and the available period information may indicate the time during which the guest key is effective in the home network.

The transmitting of the guest authentication information may be performed through a location-limited channel.

If the access of the guest device is completed, the updating of the home key for authentication of the home device excluding the guest device, may include determining whether the available period of the guest device expires with reference to the available period information of the guest device, and if the available period of the guest device does not expire, updating the home key for authentication of the home device.

Another aspect of the present invention provides an apparatus to authenticate a home device in a home network, including a database module to store and maintain a secret key received from the home device, a calculation module to generate a home key for authentication of the home device and encrypt the home key with the secret key stored in the database module, and a communication module to receive the secret key from the home device and transmit the home key encrypted by the calculation module to the home device.

### BRIEF DESCRIPTION OF THE DRAWINGS

The above and/or other aspects of the present invention will become apparent and more readily appreciated from the following detailed description of the exemplary embodiments thereof with reference to the accompanying drawings, in which:

FIG. 1 is a view illustrating home devices and a key distribution device which receives secret keys from the home devices according to an exemplary embodiment of the present invention;

FIG. 2 is a flowchart illustrating a process of generating a home key necessary for the authentication of home devices and distributing the home key according to an exemplary embodiment of the present invention;

FIG. 3 is a flowchart illustrating a process of authenticating home devices in a home network when a home device is revoked from the home network according to an exemplary embodiment of the present invention;

FIG. 4 is a flowchart illustrating a process of authenticating a guest device in a home network according to an exemplary embodiment of the present invention;

FIG. 5 is a view illustrating a system authenticating a guest device in a home network according to an exemplary embodiment of the present invention;

FIG. 6 is a view illustrating one example of a key distribution device according to an exemplary embodiment of the present invention.

### DETAILED DESCRIPTION OF EXEMPLARY EMBODIMENTS OF THE PRESENT INVENTION

Hereinafter, a home device authentication method and a system for device authentication in a home network according to exemplary embodiments of the present invention will be described in greater detail below with reference to the accompanying drawings.

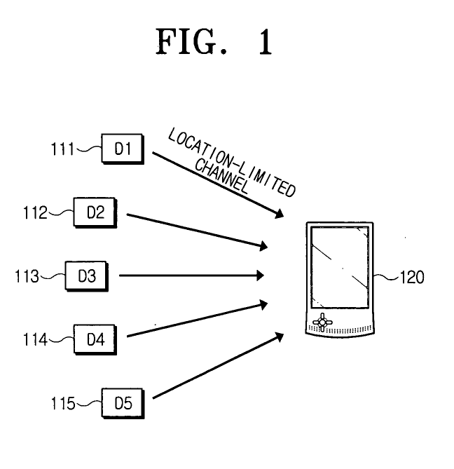

FIG. 1 is a view illustrating home devices and a key distribution device which receives secret keys from the home devices according to an exemplary embodiment of the present invention.

The home devices 111, 112, 113, 114 and 115, which have IDs of D1,D2,D3, D4 and D5, respectively, request a home network for registration. The home devices 111, 112, 113, 114 and 115 are sequentially registered on the home network.

The key distribution device 120 requests the home device 111 to transmit secret key information, including a secret key. Upon receiving the request for the secret key information from the key distribution device 120, the home device 111 transmits its own secret key information including the secret key to the key distribution device 120 using a location-limited channel. The secret key information is about the home device and further includes the ID of the home device in addition to the secret key.

The location-limited channel allows communication over only a restricted and specified narrow region, and thus, it is often utilized in a home network that mainly treats a narrow region or short-range communication. If a user moves away from the communicable region covered by the location-limited channel, it is difficult for the user to receive the communications of the communicable region. Moreover, the communicable region covered by the location-limited channel is generally within the visible range of the user. In view of these points, the use of a location-limited channel is advantageous in security maintenance.

The secret key of the home device 111 is referred to as “Se_D1.” If the home device 111 transmits the home device ID “D1” and the secret key “Se_D1” as the secret key information, the key distribution device 120 receives and stores the home device ID “D1” and the secret key “Se_D1.” Also, the key distribution device 120 stores the home device IDs and the secret keys corresponding to the home device IDs using a table. The table that shows the home device IDs and the secret keys which correspond to the home device IDs is referred to as a device registration list. The key distribution device 120 receives the home device IDs and the secret keys from the home devices and thereby creates the device registration list.

The registering operation of the home devices is completed as the above process is repeated with respect to the respective home devices.

If the home devices 112, 113, 114 and 115 are registered in sequence, the key distribution device 120 requests the home devices 112, 113, 114 and 115 to transmit the respective secret keys in the order of the home devices 112, 113, 114 and 115. Upon receiving the request for transmission of the secret keys from the key distribution device 120, the respective home devices transmit their own secret keys using the location-limited channel. For example, the key distribution device 120 receives secret keys “Se_D2,” “Se_D3,” “Se_D4” and “Se_D5” from the home devices 112, 113, 114 and 115, respectively. The key distribution device 120 creates a table showing the secret keys and the home devices which correspond to the secret keys and stores the table.

The home devices are registered one after another. That is, the home device 112 is registered after the home device 111 is registered, and the home device 113 is registered after the home device 112 is registered.

The following Table 1 is an exemplary device registration list that the key distribution device 120 creates after registering the home devices 111 to 115 in sequence.

TABLE 1

| Home Device ID | Secret Key |
|---|---|
| D1 | Se_D1 |
| D2 | Se_D2 |
| D3 | Se_D3 |
| D4 | Se_D4 |
| D5 | Se_D5 |

The key distribution device 120 stores the secret keys of all of the home devices registered on the home network. The key distribution device 120 also generates a home key for authentication in a home network. The home key is obtained as a result of a calculation by the key distribution device 120. The home devices share the home key and perform an authentication using the home key. The home key calculated by the key distribution device 120 has a random value. Therefore, if the home key is updated, the home key has a different value from the value of the home key before the updating operation Therefore, the safety of the home network can be increased.

If there is any change in the home network, for example, if a participant home device is revoked from the home network, the key distribution device 120 updates the home key. The key distribution device 120 updates the home key and performs an encryption calculation with respect to the home key using the secret keys that are received from the respective home devices. The key distribution device 120 distributes the encrypted home key to the respective home devices.

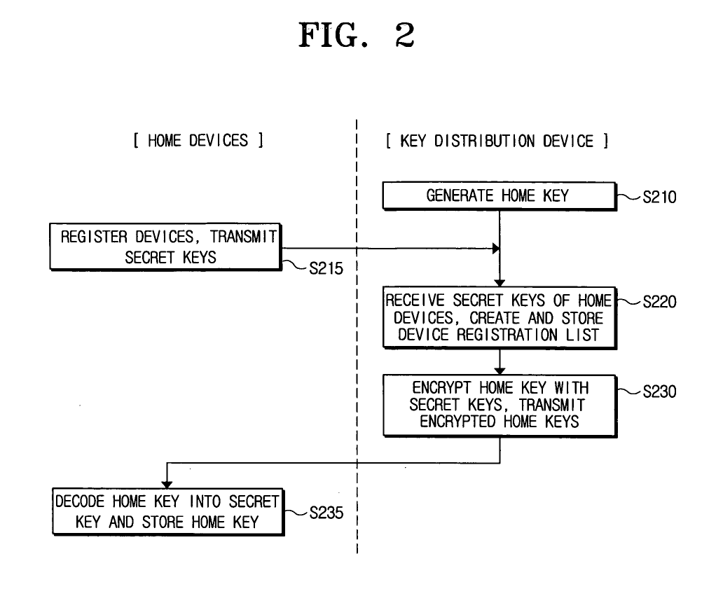

FIG. 2 is a flowchart illustrating a process of generating and distributing a home key that is necessary for the authentication of a home device according to an exemplary embodiment of the present invention.

In operation S210, a key distribution device generates a home key.

The key distribution device, which stores secret keys which correspond to respective home devices, generates a home key for authentication in a home network. The home key is obtained as a result of a calculation by the key distribution device. The home devices in the home network commonly own the home key. The home key calculated by the key distribution device has a random value. Accordingly, if the home key is updated, the home key has a different value from the value of the home key before the updating operation. Therefore, the safety of the home network can be increased.

In operation S215, home devices register themselves on the key distribution device and transmit their own respective secret keys to the key distribution device. In operation S220, the key distribution device receives the secret keys of the home devices, creates a device registration list about the registered home devices and stores the device registration list together with the secret keys.

In operation S230, the key distribution device encrypts the home key using the secret keys corresponding to the home devices and transmits the encrypted home keys to the home devices. Since the home devices own different secret keys, the encrypted home keys are different depending on the home devices.

More specifically, the key distribution device encrypts the home key with the secret keys which correspond to the home devices, with reference to the device registration list. Since the respective home devices have different secret keys, the encrypted home keys have different values depending on the corresponding home device. The key distribution device transmits the encrypted home keys to the respective home devices. Each home device decodes only the encrypted home key assigned thereto and stores the decoded home key.

The following Table 2 shows the respective home keys that are encrypted form the home key “Home_Key” with the secret keys received from the home devices by way of illustration.

TABLE 2

| Home Device ID | Secret Key | Encrypted Home Key |
|---|---|---|
| D1 | Se_D1 | E[Home_Key_Se_D1] |
| D2 | Se_D2 | E[Home_Key_Se_D2] |
| D3 | Se_D3 | E[Home_Key_Se_D3] |
| D4 | Se_D4 | E[Home_Key_Se_D4] |
| D5 | Se_D5 | E[Home_Key_Se_D5] |

It is possible to decode the encrypted home keys into the secret keys owned by the home devices. The home devices decode the encrypted home keys and store the decoded home keys. Since the respective home devices have different secret keys, the encrypted home keys are different from one another.

The encrypted home keys are decoded with the respective secret keys of the home devices. For example, the home device 111 decodes the encrypted home key “E[Home_Key_Se_D1]” received from the key distribution device with the secret key “Se_D1,” and thereby calculates and stores the original home key “Home_Key.” The home devices 112, 113, 114 and 115 calculate the home key in the same manner as that of the home device 111. The home devices receive different encrypted home keys, respectively, but store the same home key after performing the decoding process using the respective secret keys.

When receiving the encrypted home keys from the key distribution device, the home devices use the location-limited channel like the case of transmitting the secret keys to the key distribution device. The location-limited channel has a distance limitation and, thus, is suitable to a home network that does not require a long distance communication. Since the communication is performed within a visible range of a user, the user can know the contents of the communication and, thus, a safety of the network can be increased.

If a key distribution protocol is already defined for an application layer, the values encrypted with the secret keys of the respective home devices are transmitted over the network channel.

To this end, the distribution device and the respective home devices share the same home key, and thus, an authentication is performed among the home devices that are registered on the home network. The authentication in the home network is performed without requiring a server. When a certain home device requests another home device for connection, the requested home device determines whether the requesting home device owns a home key or not. If the requesting home device owns the home key, it is authenticated as a reliable home device that is registered on the home network.

The authentication is performed in a challenge-response mutual authentication method. According to the challenge-response mutual authentication method, an expectation value of a server is compared with a value obtained by hashing client information. If the value obtained by hashing the client information is equal to the expectation value of the server, the client is authenticated, and if not, the client is not authenticated.

The authentication procedure is completed if a value obtained by hashing information about a home device acting as a client is identical to an expectation value of a home device playing as a server and, thus, it is determined that the client and the server has the same home key.

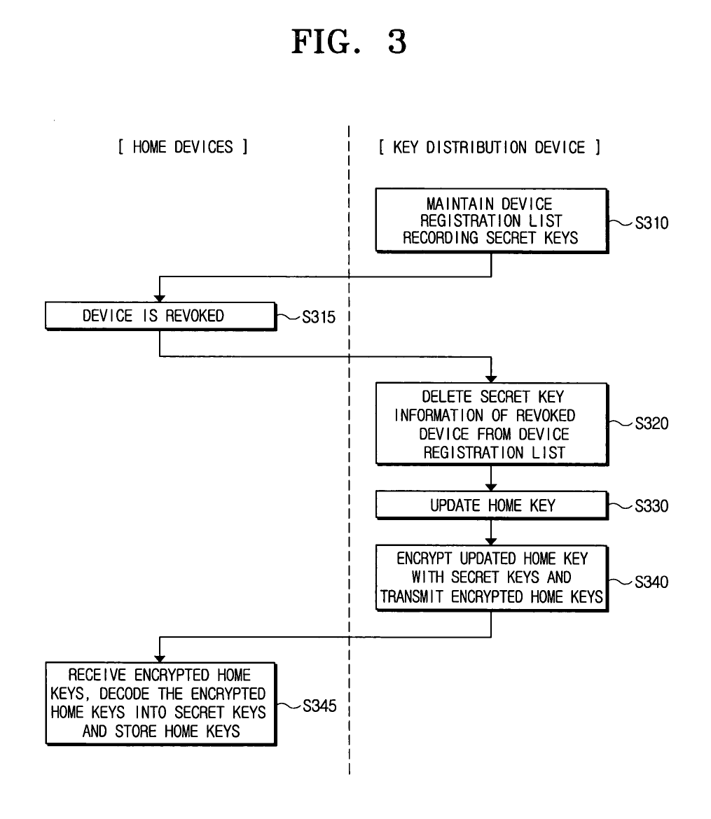

FIG. 3 is a flowchart showing a procedure of authenticating a home device in a home network when a certain home device is revoked from the home network according to an exemplary embodiment of the present invention.

In operation S310, a device registration list that records secret keys of respective home devices is maintained. The device registration list shows home device information such as IDs of the home devices registered on the home network and secret keys corresponding to the home devices. Each home device owns one or more secret key, and a key distribution device records the secret key(s) of the home devices such that the key distribution device shares the secret key(s) with the home devices.

In operation S315, a certain home device is revoked from the home network. If the revoked device is free from an influential region of the home network, a user has to notify the home network of this to prevent the revoked home device from entering the home network again without authorization.

In operation S320, when the key distribution device is notified that a certain home device has been revoked from the home network, the key distribution device deletes the secret key information of the revoked home device from the device registration list. Since the key distribution device does not need to distribute a generated home key or updated home key to the revoked home device, the key distribution device deletes the ID and the secret key of the revoked home device from the device registration list. To this end, the revoked home device does not know the generated home key or updated home key and the key distribution device is not required to perform a calculation using the secret key of the revoked home device, so that an unnecessary calculation can be prevented.

For example, if the home device 113 is revoked from the home network, the Table 1 is updated to the following Table 3:

TABLE 3

| Home Device ID | Secret Key |
|---|---|
| D1 | Se_D1 |
| D2 | Se_D2 |
| D4 | Se_D4 |
| D5 | Se_D5 |

As shown in Table 3, the home device ID D3 and the secret key Se_D3 of the home device 113 are deleted from the Table 1. No modification is required with respect to the IDs and the secret keys of the home devices other than the revoked home device 113.

In operation S330, the key distribution device updates the home key. The home key is randomly calculated by the key distribution device and has a different value from the value of the home key before updating.

In Table 1, the home key before update is referred to as “Home_Key.” The home key after the updating is referred to as “Home_Key_f02” which is different from the “Home_Key.”

In operation S340, the key distribution device encrypts the updated home key with the secret keys of the respective home keys and transmits the encrypted home keys to the respective home devices.

Since the updated home key “Home_Key_f02” is different the home key “Home_Key” before updating, the home key encrypted with the secret keys of the home devices is different from the value of the encrypted home key before updating. Accordingly, the Table 3 can be converted to the following Table 4:

TABLE 4

| Home Device ID | Secret Key | Encrypted Home Key |
|---|---|---|
| D1 | Se_D1 | E[Home_Key_f02_SeD1] |
| D2 | Se_D2 | E[Home_Key_f02_SeD2] |
| D4 | Se_D4 | E[Home_Key_f02_SeD4] |
| D5 | Se_D5 | E[Home_Key_f02_SeD5] |

In operation S345, the home devices receive the updated encrypted home keys from the key distribution device, decode the encrypted updated home keys with their respective secret keys and store the decoded updated home keys.

For example, the home device 111 receives the updated home key E[Home_Key_f02_SeD1] which has been encrypted from the updated home key from the key distribution device. The home device 111 decodes the received updated home key with the secret key “Se_D1”. As a result of decoding, the home device 111 calculates the home key “Home_Key_f02,” which is the home key updated by the key distribution device, and stores the “Home_Key_f02.”

The home devices, except for the revoked home device, store therein the updated home key through the same process as that performed by home device 111. Based on the updated home key, the home devices perform authentication of one another. The home devices 112, 114 and 115 receive the updated home key, which have been encrypted with their respective secret keys, from the key distribution device. The home devices decode the encrypted updated home keys with their respective secret keys, thereby calculating and storing the updated home key “Home_Key_f02”.

The authentication is performed among the home devices in a challenge-response mutual authentication method. The authentication is achieved if the respective home devices are founded to own the updated home key.

If a new home device subscribes to the home network, the key distribution device receives a secret key from the new home device. The new home device transmits the secret key through a location-limited channel as discussed above. The key distribution device encrypts a home key with the received secret key of the new home device and transmits the encrypted home key to the new device. Upon receiving the encrypted home key, the new home device decodes the encrypted home key using the secret key and stores the home key. When the key distribution device receives the secret key from the new home device or transmits the encrypted home key, it uses a network communication channel including the location-limited channel. Through the above process, the new home device owns the home key and thus can perform an authentication with respect to other home devices.

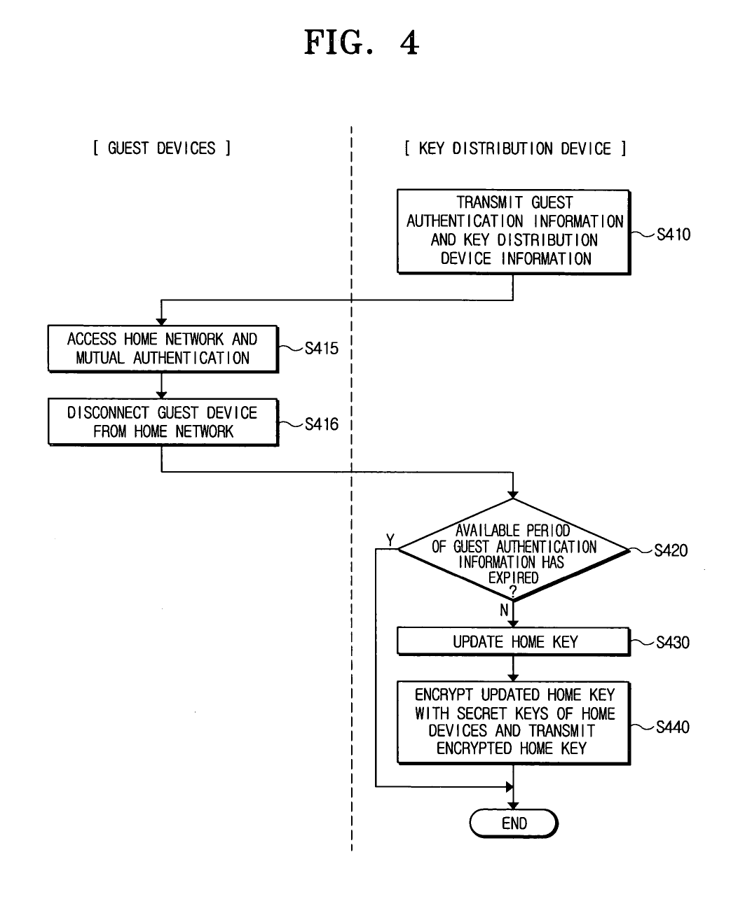

FIG. 4 is a flowchart showing a procedure of authenticating a guest device in a home network according to an exemplary embodiment of the present invention.

A guest device is not registered on the home network, but is restrictedly and temporarily joined in the home network by a user. The user allows a guest device to join the home network if necessary. Also, the user allows a visitor who is an original user of the guest device, and is not registered on the home network, to use the guest device.

In operation S410, a key distribution device transmits guest authentication information and key distribution device information to a guest device.

The guest authentication information is information for the guest device to perform an authentication in the home network, and includes a guest ID, an available period, and a guest key. The guest ID is used in the home network by the guest device and includes information about the guest device. The guest device authentication is performed only during the available period, and the guest device authentication is performed within the available period. The guest key is a key value that is generated by the key distribution device based on the home key. The guest device uses the guest key instead of the home key to perform a challenge-response authentication. The key distribution device calculates the guest key in order to prevent the guest device from knowing the home key. However, since the guest key is calculated based on the home key, the home device can obtain the guest key of the guest device through its own calculation.

The key distribution device information is information about the key distribution device that generates the guest authentication information. The key distribution device information is used to clarify the source of the guest authentication information. The key distribution device information may include network information. The network information, which is for use by the guest device, may be information about a service set identifier (SSID) if it is used to share an initially necessary key.

At step S415, the guest device receives the guest authentication information from the key distribution device, and based on the guest authentication information, accesses the home network and performs an authentication with respect to the home devices.

The guest device receives from the key distribution device the guest authentication information including the guest ID, the available period, the guest key and the key distribution device information. The guest device tries to access at least one of the home devices registered on the home network, transmits the guest authentication information, excluding the guest key and the key distribution device information, to the home device, and performs an authentication with respect to the home device. The home device receives the guest authentication information, excluding the guest key and the key distribution device information, and then checks that the available period is valid. If the available period has not expired, then the home device calculates the guest key in the same manner that the key distribution device generates the guest key through a predetermined calculation.

The authentication is performed between the home device and the guest device according to a challenge-response mutual authentication method using the guest key. This method is the same as in the case that an authentication is performed between two home devices. More specifically, a value obtained by hashing a specific value that is received from a home device acting as a server and information of a home device acting as a client is compared with an expectation value of the server device. If the two values are identical to each other, the server device authenticates the client server, and if not, the server device does not authenticate the client server.

If the authentication of the guest device is completed, the home device allows access to the guest device.

In operation S416, the guest device releases the connection with the home network and the guest device disconnects from the home network. In operation S420, the key distribution device determines whether the available period of the guest authentication information owned by the disconnected guest device has expired.

The guest device is disconnected from the home network after its intended work is successfully completed in the home network. The key distribution device receives the request for disconnection from the user and investigates the available period of the guest authentication information of the guest device. The available period of the guest authentication information indicates the time during which the guest device has authority to access the home network. If the available period of the guest authentication information expires, the guest device does not thereafter have authority to access the home network Since the guest authentication information is not available in the home network, the key distribution device does not require any action.

If the guest device is disconnected from the home network, but the available period of the guest authentication information has not yet expired, the guest device has authority to access the home network. In this case, a security of the home network may be threatened. The guest device that has the available guest authentication information can access the home network again, and steal the information, thereby threatening the safety of the home network. An illegal intruder that owns available guest authentication information is not prevented from entering the network. Therefore, the key distribution device generates a new home key, encrypts the new home key with the secret keys of the home devices and distributes the encrypted new home keys.

In operation S430, if the key distribution device finds that the guest authentication information has not expired, the key distribution device updates the home key.

More specifically, if the available period of the guest device that is disconnected from the home network has not expired, the key distribution device updates the home key and, thus, prevents the guest device from accessing the home network. The process of updating the home key is the same as the process of updating the home key discussed above with respect to the situation when a home device is revoked from the home network.

In operation S440, the key distribution device encrypts the updated home key with the secret keys of the respective home devices and transmits the encrypted home keys to the home devices.

More specifically, the key distribution device encrypts the updated home key with the secret keys of the respective home devices with reference to the device registration list, and transmits the encrypted updated home keys to the home devices. The home devices registered on the home network receive the updated and encrypted home key from the key distribution device and discard the old home key before updating. To this end, if the guest device having available guest authentication information requests access to the home network, the guest device is not authenticated because the guest authentication information is based on the old home key and, thus, has no authority to access the home network.

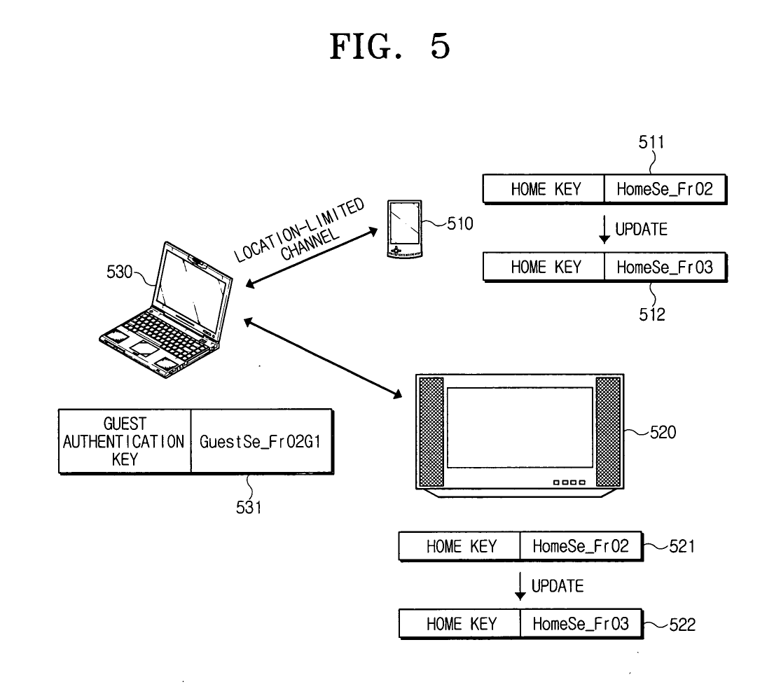

FIG. 5 is a view illustrating a system for authenticating a guest device in a home network according to an exemplary embodiment of the present invention.

For example, a key distribution device is a PDA 510, a guest device is a laptop computer 530, a home device which the guest device laptop computer 530 tries to access is a television (IV) 520, and a home key that the PDA 510 has previously transmitted to the TV 520 is “HomeSe_Fr02” 511 and 521.

A user inputs through the PDA 510 a request for guest authentication information issuance in order to authenticate the laptop computer 530 in a home network. The PDA 510 receives a guest ID and an available period for use by the laptop computer 530 in the home network from a user. Alternatively, the PDA 510 arbitrarily sets a guest ID and an available period without inputting an extra command.

For example, the user inputs a “G1” as a guest ID of the laptop computer 530 and a “PERMANENT” as an available period of the laptop computer 530. If the home device is not provided with a temporal-synchronization, it is difficult to define the available period. Therefore, a value of “PERMANENT,” which has no time limitation, is used by way of example. The PDA 510 receives the guest ID “G1” and the available period “PERMANENT” from the user and generates a guest authentication key. For example, the PDA 510 calculates a guest authentication key “GuestSe_Fr02G1” 531 with reference to a home key “HomeSe_Fr02” 511. The PDA 310 transmits guest authentication information including the guest ID “G1”, the available period “PERMANENT”, and the guest authentication key “GuestSe_Fr02G1” 531. If key distribution device information is referred to as “RemoteController_PS2,” the PDA 510 transmits the key distribution device information “RemoteController_PS2” together with the guest authentication information.

The laptop computer 530 accesses the home network after receiving the guest authentication information and the key distribution device information. The laptop computer 530 transmits the guest ID “G1” to the TV 520 as one of the home devices registered on the home network. Upon receiving the guest ID “G1”, the TV 520 finds the laptop computer 530 to be a guest device. Accordingly, the TV 520 generates a guest key and performs an authentication. The laptop computer 530 checks whether the guest authentication information is effective with reference to the available period of the guest authentication information, and if so, generates a guest key. The laptop computer 530 is authenticated if the guest authentication key “GuestSe_Fr02G1” 531 received from the PDA 510 is equal to a value obtained by a calculation of the TV 520. The authentication is performed in a challenge-response authentication method. If the authentication is completed, the laptop computer 530 is enabled to access the TV 520 and acts in the network for the available period “PERMANENT” (i.e., without limitation to the available period) and within a range defined by the user.

By way of illustration, after two hours, a visitor using the laptop computer 530 powers off the laptop computer 530 and disconnects the laptop computer 530 from the home network. The visitor leaves the home network. That is, the visitor and the visitor's guest device are revoked from the home network.

The PDA 510 is notified of the disconnection of the laptop computer 530 from the user and determines whether the available period of the guest authentication information of the laptop computer 530 has expired. Since the available period of the laptop computer 530, according to the exemplary embodiment under discussion, is “PERMANENT,” the PDA 510 knows that the guest authentication information is still available. Accordingly, the PDA 510 updates the home key “HomeSe_Fr02” 511 through a predetermined calculation. If the updated home key is “HomeSe_Fr03” 512, then the PDA 510 encrypts the updated home key “HomeSe_Fr03” 512 with the secret keys received from the respective home devices and transmits the encrypted updated home keys to the respective home devices. The TV 520 receives the encrypted updated home key and decodes the encrypted updated home key with its own secret key, thereby calculating and storing “HomeSe_Fr03.”

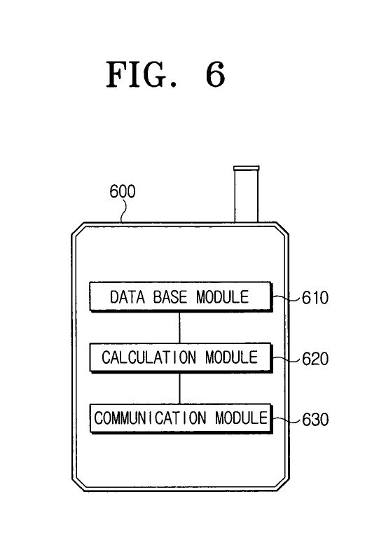

FIG. 6 is a view illustrating one example of a key distribution device according to an exemplary embodiment of the present invention.

A key distribution device 600 comprises a database module 610, a calculation module 620 and a communication module 630.

The database module 610 creates and stores a device registration list. The device registration list includes IDs of home devices that are registered on a home network and secret keys corresponding to the respective IDs.

The calculation module 620 performs all of calculations for the key distribution device 600. The calculation module 620 performs a predetermined calculation when a new home device subscribes to the home network or when a certain home device is revoked from the home network, thereby generating or updating a home key. The calculation module 620 performs a predetermined encryption calculation with respect to the home key using the secret keys of the device registration list stored in the database module 610. Also, if a guest device accesses the home network, the calculation module 620 calculates a guest authentication key based on the home key.

The communication module 630 performs all of communications for the key distribution device 600. The communication module 630 receives the IDs and the secret keys of the home devices that are registered on the home network in order for the database module 610 to record the IDs and the secret keys on the device registration list. The communication module 630 also receives the IDs and the secret keys from a user when a new home device subscribes to the home network or a certain home device is revoked from the home network such that the calculation module 620 generates or updates the home key. The generated or updated home key is transmitted to the home devices that are registered on the home network through the calculation module 620.

The communication module 630 receives a request for access of a guest device to the home network from a user, and requests the user to transmit a guest ID and an available period of the guest device and then receives the same. When the calculation module 620 calculates a guest authentication key that is necessary for the home network authentication of the guest device, the communication module 630 transmits to the guest device guest authentication information including the guest ID, the available period and the guest authentication key. If the guest device is revoked from the home network, the communication module 630 is notified of the revocation of the guest device and informs the calculation module 620 that the guest device is revoked but that the available period has not expired. The calculation module 620 then updates the home key.

According to exemplary embodiments of the present invention as described above, the method for authenticating the home devices does not require a home server, which may cause overhead, and therefore the above method processes the guest device and the revoked device more effectively.

If a new home device subscribes to the home network, or a certain home device is revoked from the home network, a user performs an authentication of the home device using the key distribution device, which results in a convenient authentication procedure.

A complicated calculation is not required in the above method since the authentication is performed using the home key distributed from the key distribution device. Also, since no home server is required and the home key is used among the home devices, overhead is not caused in the home server.

Since a guest device easily joins the home network and acts within a defined available period, the guest device is prevented from illegally entering the home network after the available period has expired.

If the guest device is revoked from the network, the home key is updated and the updated home key is distributed to the home devices. The authentication is performed mainly with respect to the home devices registered on the home network. If a home device is not registered on the home network, it is not authenticated. Accordingly, a safety of the home network is maintained.

The description of the above exemplary embodiments of the present invention is merely illustrative, and many alternatives, modifications, and variations of the exemplary embodiments of the present invention will be apparent to those skilled in the art without departing from the spirit and scope of the embodiments of the present invention as defined in the following claims.

What is claimed is:

1. A method for authenticating a home device in a home network, the method comprising:
generating a home key which is used to authenticate the home device;
receiving a secret key corresponding to the home device from the home device;
encrypting the home key with the secret key which is received;
transmitting the encrypted home key to the home device;
decoding the encrypted home key at the home device using the secret key, and
storing the home key at the home device.

2. The method as claimed in claim 1, wherein the secret key is received from the home device through a location-limited channel.

3. A method for authenticating at least two home devices including at least one new device in a home network, the method comprising:
receiving a secret key from the at least one new device;
encrypting a home key, which is used to authenticate the home devices, with the secret key which is received;
transmitting the encrypted home key to the at least one new device;
decoding the encrypted home key at the at least one new device using the secret key, and
storing the home key at the new device.

4. The method as claimed in claim 3, wherein the secret key is received from the new device and the encrypted home key is transmitted to the new device through a location-limited channel.

5. A method for authenticating a home device in a home network, the method comprising:
updating a home key which is used to authenticate the home device;
encrypting the updated home key with a secret key of the home device;
transmitting the encrypted updated home key to the home device,
decoding the encrypted home key at the home device using the secret key, and
storing the home key at the home device.

6. The method as claimed in claim 5, wherein the encrypted home key is transmitted to the home device through a network channel which comprises a location-limited channel.

7. A method for authenticating at least two home devices including at least one revoked device, the method comprising:
deleting secret key information comprising a secret key of the revoked device;
updating a home key which is used to authenticate the home devices, excluding the revoked device;
encrypting the updated home key with a secret key of a home device other than the revoked device;
transmitting the encrypted updated home key to the home device other than the revoked device;
decoding the encrypted updated home key at the home device other than the revoked device using the secret key, and
storing the home key at the home device other than the revoked device.

8. The method as claimed in claim 7, wherein the deleting of the secret key information of the revoked device, comprises:
maintaining a device registration list comprising secret keys which correspond to respective home devices; and
deleting secret key information comprising a secret key of the revoked device from the device registration list.

9. A method for authenticating a guest device in a home network, the method comprising:
receiving guest device information;
generating and transmitting guest authentication information comprising a guest key which corresponds to a previously transmitted home key, and
if an access of the guest device has completed, updating a home key which is used to authenticate home devices excluding the guest device.

10. The method as claimed in claim 9, wherein the guest authentication information comprises:
information about a guest key which is calculated based on the home key; and
available period information,
wherein the available period information indicates a time during which the guest key is effective in the home network.

11. The method as claimed in claim 9, wherein the guest authentication information is transmitted through a location-limited channel.

12. The method as claimed in claim 9, wherein if the access of the guest device has completed, the updating of the home key comprises:
determining whether an available period of the guest device has expired by referring to available period information of the guest device; and
if the available period of the guest device has not expired, then updating the home key.

13. An apparatus for authenticating a home device in a home network, the apparatus comprising:
a database module which stores and maintains a secret key that is received from the home device;
a calculation module which generates a home key, which is used to authenticate the home device, and encrypts the home key with the secret key that is stored in the database module; and
a communication module which receives the secret key from the home device and transmits the home key that is encrypted by the calculation module to the home device.
